(19) United States
(12) Patent Application Publication
(10) Pub. No.: US 2010/0045768 A1
(43) Pub. Date: Feb. 25, 2010

(54) Exposure Head, Method of Controlling Exposure Head, and Image Forming Apparatus

(75) Inventors: Yoshio ARAI, Shiojiri-shi (JP); Nozomu INOUE, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/544,096

(22) Filed: Aug. 19, 2009

(30) Foreign Application Priority Data
Aug. 20, 2008 (JP) 2008-211652

(51) Int. Cl. B41J 2/435

(52) U.S. Cl. 347/247

(57) ABSTRACT

An exposure head includes a substrate in which a first light emitting device and a second light emitting device are arranged in a direction parallel or substantially parallel to a moving direction of an exposed side to the imaged light. An imaging optical system is provided for imaging light from the first light emitting device and the second light emitting device to expose the exposed side. A control unit selects one light emitting device from the first light emitting device and the second light emitting device, allowing the selected light emitting device to emit light in accordance with a driving signal, and allowing the non-selected light emitting device to not emit light.

### RELATED APPLICATIONS

This application claims priority under 35 USC 119 in Japanese application no. 2008-211652, filed on Aug. 20, 2008, the entire contents of which are incorporated herein by reference.

### BACKGROUND

1. Technical Field

The present invention relates to an exposure head exposing an exposed side or a latent image holder to light from a light emitting device, a method of controlling the exposure head, and an image forming apparatus employing the exposure head.

2. Related Art

Conventionally, an exposure head images light from a plurality of light emitting devices by the use of an imaging optical system that exposes the surface (exposed side) of the latent image holder. For example, in JP-A-2006-231649, a plurality of light emitting devices are arranged at different positions in a main scanning direction so that light from the light emitting devices is imaged by an imaging optical system to form spots at the different positions in the main scanning directions. In this way, a latent image corresponding to one line in the main scanning direction is formed. By allowing the light emitting devices to emit light at a time corresponding to the movement of the surface of the latent image holder in a sub scanning direction perpendicular to the main scanning direction, plural latent images corresponding to the lines are formed in the sub scanning direction to form a two-dimensional latent image.

LED (light Emitting Diodes) or organic EL (Electroluminescence) devices can be employed as the light emitting devices. However, these devices are exhausted due to the repeated emission of light. When the light emitting devices are exhausted and thus cannot emit light with the light intensity necessary for forming a latent image, a streaky area in which the latent image is not formed may occur in the sub scanning direction. Thus, the latent image may not be formed well. In this case, it is necessary to replace the exposure head with a new one. However, the light emitting devices should emit light with the movement of the surface of the latent image holder moving at a high speed so as to cope with the recent requirement for an increase in printing speed. Also, the light emitting devices need to emit light with the higher intensity to satisfactorily form a latent image for a short time. However, the light emitting devices are more rapidly exhausted by increasing the light intensity of the light emitting devices. As a result, the lifetime of the exposure head is shortened and an operation of replacing the exposure head should be performed frequently, which may be a great burden on a user.

### SUMMARY

One advantage of the invention is that it provides a technique for elongating the lifetime of an exposure head to reduce the frequency of the operation of replacing the exposure head.

According to one aspect of the invention, an exposure head includes a substrate in which a first light emitting device and a second light emitting device are arranged in a direction parallel or substantially parallel to a moving direction of an exposed side. An imaging optical system imaging light is provided from the first light emitting device and the second light emitting device to expose the exposed side to the imaged light. A control unit selects one light emitting device from the first light emitting device and the second light emitting device, allowing the selected light emitting device to emit light in accordance with a driving signal, and allowing the non-selected light emitting device not to emit light.

According to another aspect of the invention, there is provided a method of controlling an exposure head, including selecting one light emitting device of a first light emitting device and a second light emitting device arranged in a direction parallel or substantially parallel to a moving direction of an exposed side in an exposure head. The selected light emitting device is allowed to emit light in accordance with a driving signal to expose the exposed side to the emitted light. The method allows the non-selected light emitting device not to emit light.

According to yet another aspect of the invention, there is provided an image forming apparatus including a latent image holder and an exposure head having a substrate in which a first light emitting device and a second light emitting device are arranged in a direction parallel or substantially parallel to a moving direction of the latent image holder. An imaging optical system is provided imaging light from the first light emitting device and the second light emitting device to expose the latent image holder to the imaged light. Here, one light emitting device is selected from the first light emitting device and the second light emitting device, and the selected light emitting device is allowed to emit light in accordance with a driving signal. The non-selected light emitting device is allowed not to emit light.

In the aspects of the inventions (the exposure head, the method of controlling an exposure head, and the image forming apparatus) having the above-mentioned configurations, the exposed side moves in the moving direction and the exposed side is exposed by allowing the imaging optical system to image the light from the light emitting device. Therefore, when the light emitting device is exhausted, the latent image cannot be formed well and thus the exposure head should be replaced.

In the above-mentioned configuration, the first light emitting device and the second light emitting device are provided. Since the first light emitting device and the second light emitting device are arranged in the direction parallel or substantially parallel to the moving direction of the exposed side, the light emitting devices can expose the same area of the exposed side. The selected light emitting device of the first light emitting device and the second light emitting device emits light in accordance with the driving signal to form a latent image and the non-selected light emitting device does not emit light not to form a latent image. Therefore, for example, when the formation of latent images is repeatedly performed by the use of the first light emitting device and the first light emitting device is exhausted as a result, the second light emitting device can be selected to continuously perform the formation of latent images by the use of the second light emitting device. Accordingly, it is possible to continuously form a latent image without replacing the exposure head. In this manner, it is possible to elongate the lifetime of the exposure head and to reduce the frequency of the operation of replacing the exposure head.

In a configuration in which the light emitting devices are driven with a current to emit light, the control unit may be constructed as follows. The control unit may include a current output circuit outputting a driving current corresponding to the driving signal, a selection circuit selecting one light emitting device of the first light emitting device and the second light emitting device, and a current supply switching circuit supplying the driving current to the light emitting device selected by the selection circuit and not supplying the driving current to the light emitting device not selected by the selection circuit. In this configuration, by only switching the supply destination of the driving current by the use of the current supply switching circuit, it is possible to simply switch the light emitting device to emit light, thereby simplifying the emission control of the light emitting devices.

The current supply switching circuit may include a first switch outputting the driving current input to an input terminal from an output terminal connected to the first light emitting device in an ON period of time, a second switch outputting the driving current input to an input terminal from an output terminal connected to the second light emitting device in the ON period of time, and an ON-OFF switching circuit turning on one switch, which is connected to the light emitting device selected by the selection circuit, of the first switch and the second switch and turning off the other switch which is connected to the light emitting device not selected by the selection circuit. In this configuration, by only switching the ON and OFF states of the first switch and the second switch by the use of the ON-OFF switching circuit, it is possible to simply switch the supply destination of the current, thereby simplifying the switching control of the light emitting devices.

The current output circuit may include a transistor of which the source is connected to a constant voltage source, of which the gate is supplied with a voltage corresponding to the driving signal, and which outputs the driving current corresponding to a difference in voltage between the source and the gate from the drain. In this configuration, since the driving current to be supplied to the first light emitting device or the second light emitting device can be simply generated by the use of only one transistor, it is possible to simplify the configuration.

The control unit may be disposed in the substrate. In this configuration, since the light emitting devices and the control unit can be disposed relatively close to each other, it is possible to reduce the size of the exposure head.

The first light emitting device and the second light emitting device maybe organic EL devices. That is, the organic EL device tends to be exhausted more rapidly than an LED device. Therefore, when the invention is applied to the exposure head employing the organic EL device as the light emitting device, it is possible to elongate the lifetime of the exposure head and thus to reduce the frequency of the operation of replacing the exposure head.

### BRIEF DESCRIPTION OF THE DRAWINGS

The invention will be described with reference to the accompanying drawings, wherein like numbers reference like elements.

FIG. 1 is a diagram illustrating an image forming apparatus according to an embodiment of the invention.

FIG. 2 is a diagram illustrating an electrical configuration of the image forming apparatus shown in FIG. 1.

FIG. 3 is a perspective view illustrating a structure of a line head.

FIG. 4 is a partial sectional view illustrating the structure of the line head.

FIG. 5 is a plan view illustrating a configuration of a light emitting device array disposed on a rear surface of a head substrate.

FIG. 6 is a circuit diagram illustrating a configuration of an emission control circuit controlling the emission of light emitting devices.

FIG. 7 is a flowchart illustrating an example of a switching operation performed by a head controller.

FIG. 8 is a flowchart illustrating another example of the switching operation performed by the head controller.

### DESCRIPTION OF EXEMPLARY EMBODIMENTS

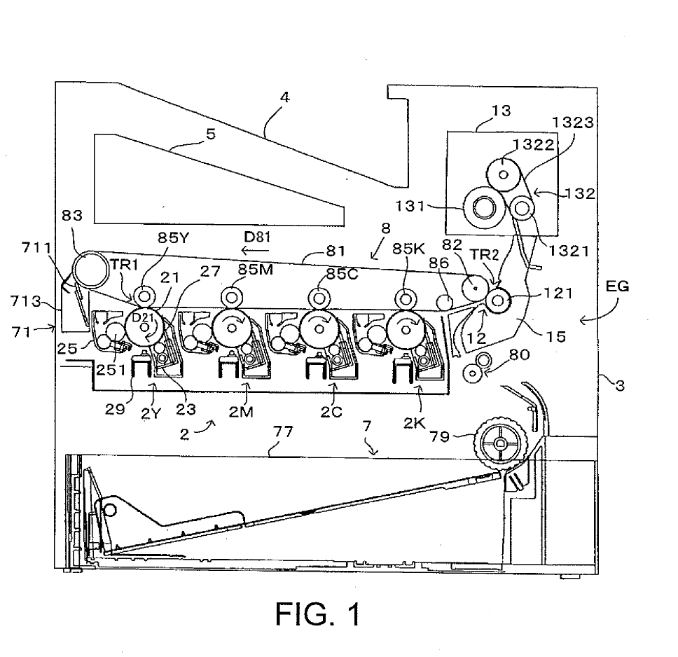

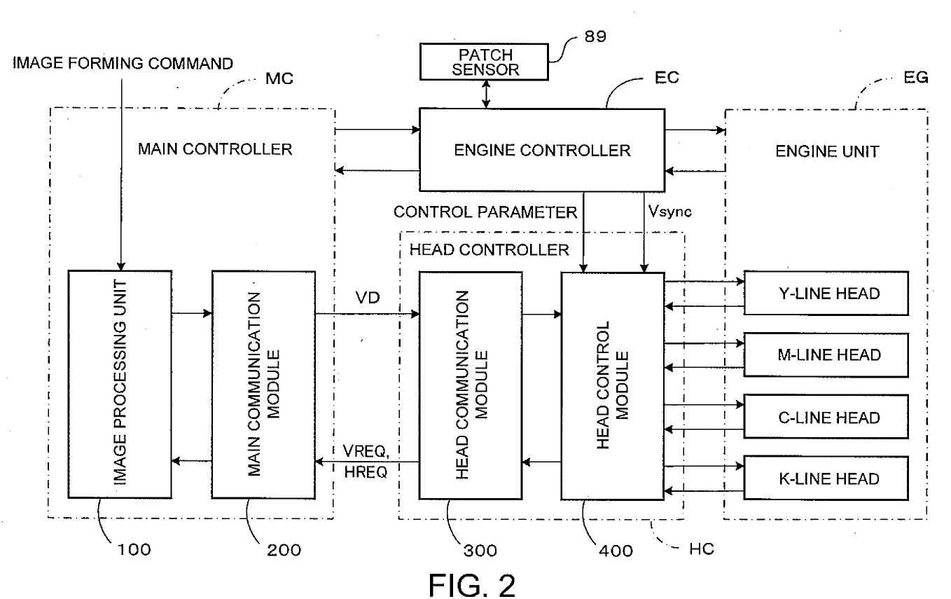

FIG. 1 is a diagram illustrating an image forming apparatus according to an embodiment of the invention. FIG. 2 is a diagram illustrating an electrical configuration of the image forming apparatus shown in FIG. 1. The inventive apparatus is an image forming apparatus capable of selectively operating in a color mode in which a color image is formed in an overlapping manner using four color toner of yellow (Y), magenta (M), cyan (C), and black (K) and a monochrome mode in which a monochromatic image is formed using only the toner of black (K). In the image forming apparatus, when an image forming command is given to a main controller MC including a CPU or a memory from an external apparatus such as a host computer, the main controller MC gives a control signal to an engine controller EC and the engine controller EC controls the respective units such as an engine unit EG and the head controller HC on the basis of the control signal to perform a predetermined image forming operation, whereby an image corresponding to the image forming command is formed on a recording sheet such as copying paper, transfer paper, plain paper, and OHP transparent sheet.

A housing body 3 of the image forming apparatus according to this embodiment is provided with an electrical component box 5 having a power supply circuit board, a main controller MC, an engine controller EC, and a head controller HC built therein. An image forming unit 2, a transfer belt unit 8, and a sheet feed unit 7 are disposed in the housing body 3. A secondary transfer unit 12, a fixing unit 13, and a sheet guiding member 15 are disposed on the right side in the housing body 3 in FIG. 1. The sheet feed unit 7 can be attached and detached to and from the housing body 3. The sheet feed unit 7 and the transfer belt unit 8 can be detached to repair or replace them.

The image forming unit 2 includes four image forming stations 2Y (yellow), 2M (magenta), 2C (cyan), and 2K (black) forming images of different colors. In FIG. 1, since the configurations of the image forming stations of the image forming unit 2 are equal to each other, only some image forming stations are referenced by reference numerals for the purpose of convenient illustration and the other image forming stations are not denoted by reference numerals.

The respective image forming stations 2Y, 2M, 2C, and 2K are provided with photosensitive drums 21 in which toner images of the colors are formed on the surfaces thereof, respectively. The rotation axes of the photosensitive drums 21 are disposed parallel or substantially parallel to a main scanning direction MD (in a direction perpendicular to the drawing sheet of FIG. 1). The photosensitive drums 21 are connected to exclusive driving motors, respectively, and are rotationally driven at a predetermined speed in a direction indicated by an arrow D21 in FIG. 1. Accordingly, the surfaces of the photosensitive drums 21 are transported in a sub scanning direction SD perpendicular or substantially perpendicular to the main scanning direction MD. A charging unit 23, a line head 29, a developing unit 25, and a photosensitive drum cleaner 27 are disposed around each photosensitive drum 21 along the rotation direction thereof. A charging operation, a latent image forming operation, and a toner developing operation are carried out by these functional units. At the time of operating in the color mode, the toner images formed by all the image forming stations 2Y, 2M, 2C, and 2K are made to overlap with a transfer belt 81 disposed in the transfer belt unit 8 to form a color image. At the time of operating in the monochrome mode, only the image forming station 2K is made to operate to form a monochromatic black image.

The charging unit 23 includes a charging roller of which the surface is formed of elastic rubber. The charging roller comes in contact with the surface of the photosensitive drum 21 at a charging position and follows the rotation of the photosensitive drum 21. That is, the charging roller rotates with the rotation of the photosensitive drum 21. The charging roller is connected to a charging bias generator (not shown), and is supplied with a charging bias from the charging bias generator, and charges the surface of the photosensitive drum 21 to a predetermined surface potential at the charging position where the charging unit 23 comes in contact with the photosensitive drum 21.

The line head 29 is disposed so that the longitudinal direction LGD thereof is parallel to or substantially parallel to the main scanning direction MD and the width direction LTD thereof is parallel or substantially parallel to the sub scanning direction SD. The line head 29 includes plural light emitting devices arranged in the longitudinal direction LGD and is opposed to the photosensitive drum 21. Light is applied to the surface of the photosensitive drum 21 charged by the charging unit 23 from the light emitting devices to form an electrostatic latent image on the surface thereof.

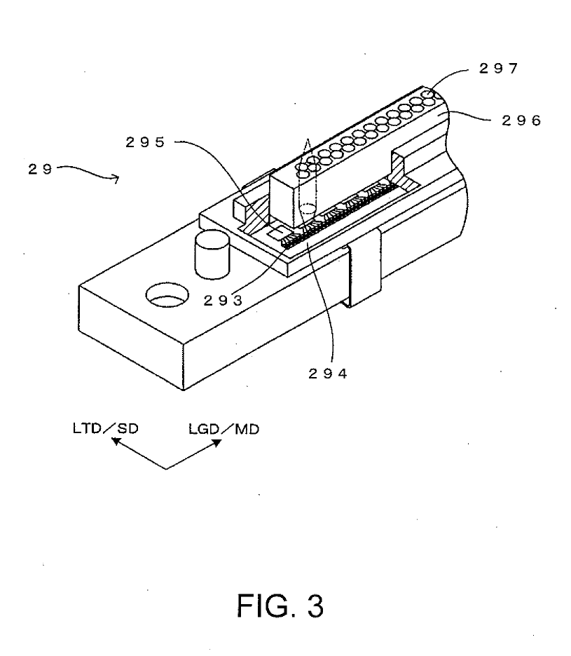

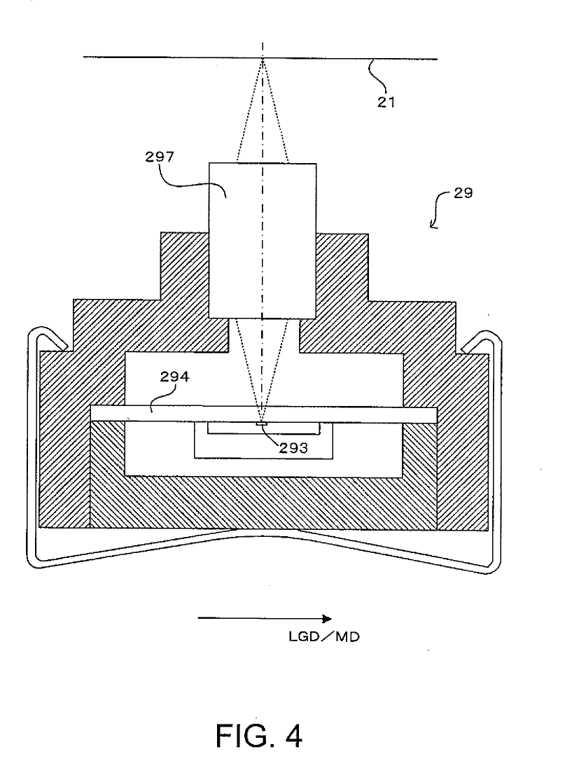

FIG. 3 is a perspective view illustrating a structure of the line head. In the drawing, the rear configuration of a head substrate 294 is shown and the front configuration is omitted. Among the two surfaces of the head substrate 294, the upper surface in the drawing is a front surface and the lower surface in the drawing is a rear surface. FIG. 4 is a partial sectional view illustrating a structure of the line head. The rear surface of the head substrate 294 of the line head 29 is provided with light emitting device arrays 293 in which bottom-emission organic EL devices are formed as light emitting devices E. The rear surface of the head substrate 294 is provided with an emission control circuit 295 (omitted in FIG. 4) allowing the light emitting devices E to emit light on the basis of video data VD. The emission control circuit 295 can be formed of a TFT (Thin Film Transistor). Gradient index rod lens arrays 297 are disposed to correspond to the emission surfaces of the light emitting devices E. Light beams emitted from the light emitting devices E are imaged at the same upright magnification by the gradient index rod lens arrays 297 and thus spots are formed on the surface of the photosensitive drum 21. Accordingly, an electrostatic latent image corresponding to the video data VD is formed on the surface of the photosensitive drum 21.

The configuration of the image forming apparatus will be continuously described with reference to FIG. 1. The developing unit 25 includes a developing roller 251 holding toner on the surface thereof. With the developing bias applied to the developing roller 251 from the developing bias generator (not shown) electrically connected to the developing roller 251, the charged toner moves from the developing roller 251 to the photosensitive drum 21 at a developing position where the developing roller 251 and the photosensitive drum 21 come in contact with each other and thus the electrostatic latent image formed on the surface thereof is developed.

The toner image developed at the developing position is transported in the rotation direction D21 of the photosensitive drum 21 and then is primarily transferred to the transfer belt 81 at a primary transfer position TR1 where the transfer belt 81 to be described in detail later and the photosensitive drum 21 come in contact with each other.

A photosensitive drum cleaner 27 is disposed on the downstream side of the primary transfer position TR1 and the upstream side of the charging unit 23 in the rotation direction D21 of the photosensitive drum 21 so as to come in contact with the surface of the photosensitive drum 21. The photosensitive drum cleaner 27 removes the toner remaining on the surface of the photosensitive drum 21 after the primary transfer by coming in contact with the surface of the photosensitive drum.

The transfer belt unit 8 includes a driving roller 82, a driven roller 83 (blade-opposing roller) disposed on the left side of the driving roller 82 in FIG. 1, and a transfer belt 81 suspended on the rollers and rotationally driven in the direction of arrow D81 (transport direction) with the rotation of the driving roller 82. The transfer belt unit 8 further includes four primary transfer rollers 85Y, 85M, 85C, and 85K which are disposed inside the transfer belt 81 to correspond to the photosensitive drums 21 of the image forming stations 2Y, 2M, 2C, and 2K at the time of mounting a cartridge, respectively. The primary transfer rollers are electrically connected to primary transfer bias generators (not shown).

At the time of operating in the color mode, as shown in FIGS. 1 and 2, the transfer belt 81 is pressed and abutted on the photosensitive drums 21 of the image forming stations 2Y, 2M, 2C, and 2K to form the primary transfer positions TR1 between the photosensitive drums 21 and the transfer belt 81, by positioning all the primary transfer rollers 85Y, 85M, 85C, and 85K at the image forming stations 2Y, 2M, 2C, and 2K. Then, by applying a primary transfer bias to the primary transfer roller 85Y and the like from the primary transfer bias generators at a proper time, the toner images formed on the surfaces of the photosensitive drums 21 are transferred to the surface of the transfer belt 81 at the corresponding primary transfer positions TR1. That is, in the color mode, the monochromatic toner images of the colors overlap with each other on the transfer belt 81 to form a color image.

The transfer belt unit 8 further includes a downstream guide roller 86 disposed on the downstream side of the black primary transfer roller 85K and on the upstream side of the driving roller 82. The downstream guide roller 86 comes in contact with the transfer belt 81 on a common tangential line between the primary transfer roller 85K and the black photosensitive drum 21 (K) at the primary transfer position TR1 formed by bringing the primary transfer roller 85K and the photosensitive drum 21 of the image forming station 2K into contact with each other.

A patch sensor 89 is disposed to face the surface of the transfer belt 81 wound on the downstream guide roller 86. The patch sensor 89 is formed of, for example, a reflecting photo sensor and detects a position or a concentration of a patch image formed on the transfer belt 81 as needed by optically detecting a change in reflectance of the surface of the transfer belt 81.

The sheet feed unit 7 includes a sheet feeder having a sheet feed cassette 77 on which sheets can be piled and maintained and also includes a pickup roller 79 feeding the sheets one by one from the sheet feed cassette 77. The sheet fed from the sheet feeder by the pickup roller 79 is adjusted in feed time by a registration roller pair 80 and then is fed to a secondary transfer position TR2 where the driving roller 82 and the secondary transfer roller 121 come in contact with each other along the sheet guiding member 15.

The secondary transfer roller 121 is provided to come in contact with and separate from the transfer belt 81 and is driven to come in contact and separate by a secondary transfer roller driving mechanism (not shown) The fixing unit 13 includes a heating roller 131 having a heating body such as a halogen heater built therein and freely rotating and also includes a pressing section 132 pressing and urging the heating roller 13l. The sheet having an image secondarily transferred onto the surface thereof is guided to a nip portion formed by the heating roller 131 and a pressing belt 1323 of the pressing section 132 by the use of the sheet guide member 15 such that the image is thermally fixed at the nip portion at a predetermined temperature. The pressing section 132 includes two rollers 1321 and 1322 and a pressing belt 1323 suspended thereon. By pressing a belt surface, which is suspended on two rollers 1321 and 1322, of the surfaces of the pressing belt 1323 against the peripheral surface of the heating roller 131, the nip portion can be formed wide by the heating roller 131 and the pressing belt 1323. The sheet having been subjected to the fixing process is transported to a sheet discharge tray 4 disposed on the top surface of the housing body 3.

The driving roller 82 rotationally drives the transfer belt 81 in the direction of arrow D81 in the drawing and also serves as a backup roller of the secondary transfer roller 121. A rubber layer (with a thickness of about 3 mm and a volume resistivity of 1000 kΩcm or less is formed on the peripheral surface of the driving roller 82 and is grounded through a metal shaft to form a conductive path of the second transfer bias supplied from a secondary transfer bias generator not shown via the secondary transfer roller 121. In this way, by providing the rubber layer having high-friction and impact-absorbing characteristics to the driving roller 82, it is possible to prevent a deterioration in image quality due to transmission of impact to the transfer belt 81 when the sheet enters the secondary transfer position TR2.

In the apparatus, a cleaner unit 71 is disposed to face the blade-opposing roller 83. The cleaner unit 71 includes a cleaner blade 711 and a waste toner box 713. The cleaner blade 711 removes particles of toner or paper dust remaining on the transfer belt 81 after the secondary transfer by bringing its front end into contact with the blade-opposing roller 83 with the transfer belt 81 interposed therebetween. The removed particles are collected in the waste toner box 713. The cleaner blade 711 and the waste toner box 713 are formed integrally with the blade-opposing roller 83.

In this embodiment, the photosensitive drum 21, the charging unit 23, the developing unit 25, and the photosensitive drum cleaner 27 of the respective image forming stations 2Y, 2M, 2C, and 2K are formed integrally in a unit as a cartridge. The cartridges can be attached and detached to and from the apparatus body. A non-volatile memory storing information on the corresponding cartridge is provided to each cartridge. A radio communication is made between the engine controller EC and the cartridges. Accordingly, the information on the corresponding cartridge is transmitted to the engine controller EC and information of each memory is updated and stored. The use history of each cartridge or the lifetime of expendables is managed on the basis of the information.

In this embodiment, the main controller MC, the head controller HC, and the line heads 29 are independently constructed as separate blocks and the blocks are connected to each other via serial communication lines. An operation of exchanging data between the blocks will be described with reference to FIG. 2. When an image forming command is given to the main controller MC from an external apparatus, the main controller MC transmits a control signal for starting up the engine unit EG to the engine controller EC. An image processor 100 disposed in the main controller MC performs a predetermined signal process on image data included in the image forming command to generate video data VD of each toner color.

On the other hand, the engine controller EC having received the control signal starts the initialization and warming-up of the constituent parts of the engine unit EG. When the initialization and the warming-up are finished in a state where an image forming operation can be carried out, the engine controller EC outputs a synchronization signal Vsync for triggering the image forming operation to the head controller HC controlling the line heads 29.

The head controller HC includes a head control module 400 controlling the line heads and a head communication module 300 performing a data communication with the main controller MC. On the other hand, the main controller MC also includes a main communication module 200. A vertical request signal VREQ indicating the head of an image corresponding to one page and a horizontal request signal HREQ requesting for the video data corresponding to one line of the image are transmitted to the main communication module 200 from the head communication module 300. On the other hand, the video data VD is transmitted to the head communication module 300 from the main communication module 200 in accordance with the request signals. More specifically, when the main communication module receives the horizontal request signal HREQ after receiving the vertical request signal VREQ indicating the head of an image, it sequentially outputs the video data VD corresponding to one line from the head of the image. The light emitting devices E emit light on the basis of the video data VD.

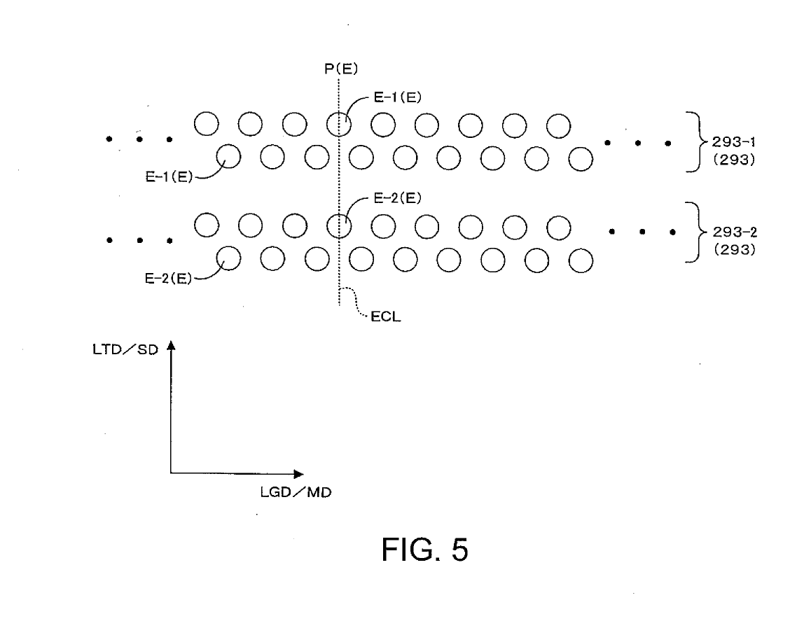

FIG. 5 is a plan view illustrating a configuration of the light emitting device arrays disposed on the rear surface of the head substrate. As shown in FIG. 5, in this embodiment, two light emitting device arrays 293-1 and 293-2 are arranged in the width direction LTD. Two lines of light emitting devices E are arranged in a zigzag in each of the light emitting device arrays 293-1 and 293-2. The light emitting devices E-1 of the light emitting device array 293-1 and the light emitting devices B-2 of the light emitting device array 293-2 are arranged to correspond to each other one to one and the two corresponding light emitting devices E-1 and E-2 are arranged in the width direction LTD to form a light emitting device column ECL. In this way, since two light emitting devices E-1 and E-2 forming the light emitting device column ECL are located at the same position P(E) in the longitudinal direction LGD, they can form a spot in the same area on the surface of the photosensitive drum 21. As described later, one of the light emitting devices E-1 and E-2 of the light emitting device column ECL selectively emits light, which is provided to form a latent image.

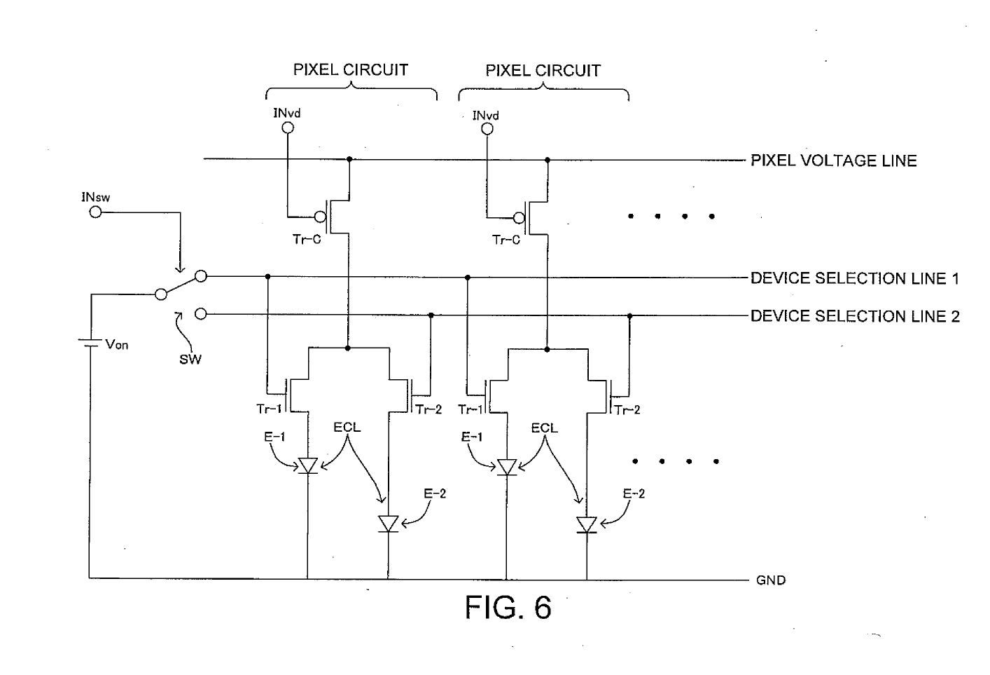

FIG. 6 is a circuit diagram illustrating a configuration of a emission control circuit controlling the emission of light of the respective light emitting devices. As shown in FIG. 6, a pixel circuit includes a constant-current transistor Tr-C and two selection transistors Tr-1 and Tr-2 disposed in each light emitting device column ECL. The source of the constant-current transistor Tr-C is connected to a pixel voltage line supplying a constant voltage and the gate of the constant-current transistor Tr-C is connected to an input terminal INvd of the video data VD. Therefore, the constant-current transistor Tr-C outputs a driving current corresponding to the video data VD from the drain thereof. The drain of the constant-current transistor Tr-C is connected to the input terminals of the selection transistors Tr-1 and Tr-2 serving as a switch.

Device selecting line 1 is connected to the gate of the selection transistor Tr-1 and device selecting line 2 is connected to the gate of the selection transistor Tr-2. Each of device selecting line 1 and device selecting line 2 is connected to a constant voltage source via a switch SW and one of device selecting line 1 and device selecting line 2 is supplied with an ON voltage from the constant voltage source by switching the switch SW. The output terminal of the selection transistor Tr-1 is connected to the light emitting device E-1 and the output terminal of the selection transistor Tr-2 is connected to the light emitting device E-2. Therefore, by turning on the selection transistor Tr-1 in the state where the ON voltage Von is supplied to device selecting line 1, the driving current is supplied to the light emitting device E-1. On the other hand, by turning on the selection transistor Tr-2 in the state where the ON voltage Von is supplied to device selecting line 2, the driving current is supplied to the light emitting device E-2.

The switching of the switch SW is performed by the head controller HC. That is, the head controller HC determines which of the light emitting devices E-1 and E-2 should be made to emit light. Specifically, the switching of the switch SW is performed as follows.

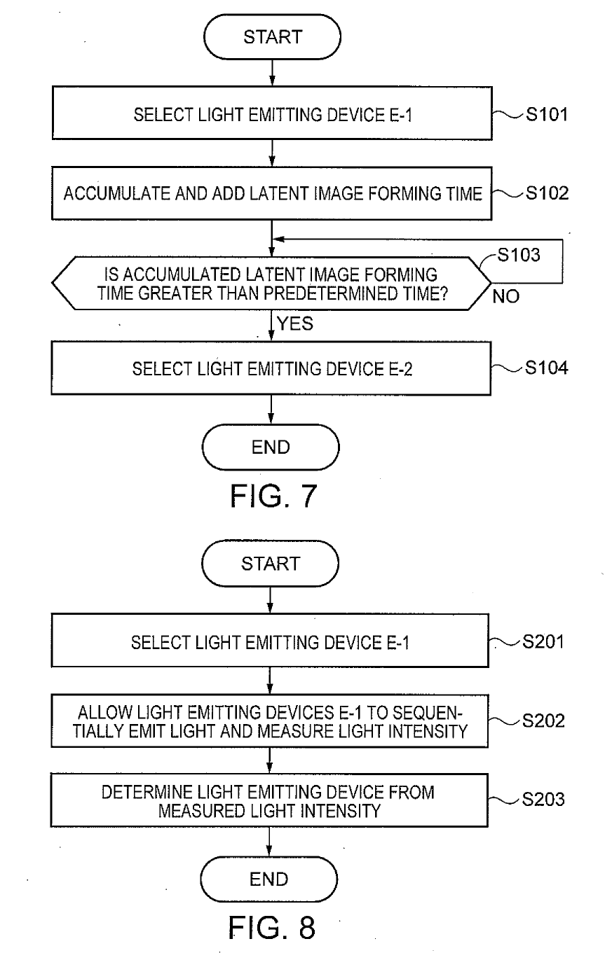

FIG. 7 is a flowchart illustrating an example of a switching operation performed by the head controller. As shown in FIG. 7, when the line head 29 forms a latent image in a new product state, the light emitting device E-1 is selected and is provided to form the latent image (step S101). The latent image forming time is accumulated and added every time a latent image is formed (step S102). When the accumulated latent image forming time is equal to or greater than a predetermined time (Yes in step S103), it is determined that the light emitting device E-1 is exhausted and the switch SW is switched (step S104). In this way, the light emitting device E-2 is selected and provided to form a latent image.

In this embodiment, the selected light emitting device E of the light emitting devices E-1 and E-2 emits light on the basis of the video data VD to form a latent image and the non-selected light emitting device E does not emit light and thus does not form a latent image. Therefore, when the light emitting device E-1 is repeatedly used to form a latent image and the light emitting device E-1 is exhausted as a result, the light emitting device E-2 can be selected to continuously form a latent image by the use of the light emitting device E-2. Accordingly, it is possible to continue to form a latent image without replacing the line head 29. Accordingly, in this embodiment, it is possible to elongate the lifetime of the line head 29 and thus to reduce the frequency of the operation of replacing the line head 29.

In this embodiment, the emission control circuit 295 includes a constant-current transistor Tr-C outputting a driving current corresponding to the video data VD and a current supply switching circuit (switch SW and selection transistors Tr-1 and Tr-2) supplying the driving current to the light emitting device E selected by the head controller HC and not supplying the driving current to the light emitting device E not selected by the head controller HC. In this configuration, by only switching the destination of the driving current using the current supply switching circuit, the light emitting device E to emit light can be simply switched, thereby simplifying the emission control of the light emitting device E.

In this embodiment, the current supply switching circuit includes a first switch (selection transistor Tr-1) outputting the driving current input to the input termination thereof from the output terminal connected to the light emitting device E-1 in the ON period of time, a second switch (selection transistor Tr-2) outputting the driving current input to the input terminal thereof from the output terminal connected to the light emitting device E-2 in the ON period of time, and an ON-OFF switching circuit (switch SW) turning on one switch, which is selected by the head controller HC among the first and second switches (selection transistor Tr-1 and selection transistor Tr-2), connected to the light emitting device E and turning off the other switch, which is not selected by the head controller HC connected to the light emitting device E. In this configuration, by only switching the ON and OFF states of the first and second switches (selection transistor Tr-1 and selection transistor Tr-2) by the use of the ON-OFF switching circuit (switch SW), it is possible to simply switch the destination of the current, thereby simplifying the switching control of the light emitting devices E.

In this embodiment, the driving current to be supplied to the light emitting devices E-1 and E-2 can be generated by only one constant-current transistor Tr-C, thereby simplifying the configuration.

In this embodiment, the emission control circuit 295 is disposed in the head substrate 294. Therefore, the light emitting devices E and the emission control circuit 295 can be disposed relatively close to each other, thereby reducing the size of the line head 29.

In this embodiment, the light emitting devices E are organic EL devices. The organic EL devices tend to be exhausted more rapidly than the LED devices or the like. Therefore, as described above, the invention can be applied to the line head 29 using the organic EL devices as the light emitting devices E, thereby elongating the lifetime of the line head 29 and reducing the frequency of the operation of replacing the line head 29.

In the above-mentioned embodiment, the line head 29 corresponds to the “exposure head” in the claims, the head controller HC corresponds to the “selection circuit” in the claims, the head controller HC and the emission control circuit 295 corresponds to the “control unit” in the claims, the photosensitive drum 21 corresponds to the “latent image holder” in the claims, the surface of the photosensitive drum 21 corresponds to the “exposed side” in the claims, the light emitting device E-l corresponds to the “first light emitting device (or second light emitting device)” in the claims, the light emitting device E-2 corresponds to the “second light emitting device (or first light emitting device)” in the claims, and the video data VD corresponds to the “driving signal” in the claims. The constant-current transistor Tr-C corresponds to the “current output circuit” in the claims and the circuit including the switch SW, the selection transistor Tr-1, and the selection transistor Tr-2 corresponds to the “current supply switching circuit” in the claims

The invention is not limited to the above-mentioned embodiments, but may be modified in various forms without departing from the gist of the invention. For example, although the light emitting devices E used to form a latent image are switched on the basis of the accumulated latent image forming time in the above-mentioned embodiment, the switching operation performed by the head controller is not limited to the embodiment.

FIG. 8 is a flowchart illustrating another example of the switching operation performed by the head controller. As described in step S201, when the line head 29 forms a latent image in a new product state, the, above-mentioned embodiment and the embodiment shown in FIG. 8 are common in that the light emitting devices E-1 are selected and provided to form a latent image. However, the embodiments are different from each other in the following description. In the embodiment shown in FIG. 8, the process of step S202 is performed at the point in time of not forming a latent image such as times between formations of the latent images. In step S202, the light emitting devices E-1 sequentially emit light and the emission intensity is detected by an optical sensor. The optical sensor may be provided on the surface of the head substrate 294. For example, when the light intensity of a certain light emitting device E-1 is equal to or less than a predetermined value, it is determined that the light emitting devices E-1 are exhausted and the switch SW is switched (step S203). In this way, the light emitting devices E-2 are selected and provided to form a latent image.

In the above-mentioned embodiment, the light emitting devices E are the organic EL devices, but the light emitting devices E are not limited to the organic EL devices. For example, the light emitting devices E may be LED devices.

In the above-mentioned embodiment, the plural light emitting devices E in two lines are arranged in a zigzag in each light emitting device array 293, but plural light emitting devices E in three or more lines may be arranged in a zigzag or the light emitting devices may be arranged in a line.

In the above-mentioned embodiment, two light emitting device arrays 293 are arranged in the width direction LTD, but three or more light emitting device arrays 293 may be arranged in the width direction LTD. That is, by selectively using one light emitting device array 293 of the light emitting device arrays 293 arranged in this way to form a latent image, it is possible to elongate the lifetime of the line head 29 and to reduce the frequency of the operation of replacing the line head 29.

In the above-mentioned embodiment, the light emitting devices E used to form a latent image in all the light emitting device columns ECL are switched from the light emitting devices E-1 to the light emitting devices E-2 at the time of switching the light emitting devices. However, when it is determined in step S202 shown in FIG. 8 that the light intensity of the light emitting device E-1 in a specific light emitting device column ECL is lowered, the light emitting devices E used to form a latent image in only the specific light emitting device column ECL may be switched from the light emitting devices E-1 to the light emitting devices E-2.

In the above-mentioned embodiment, the light emitting devices E-1 are used to form a latent image when the line head 29 forms a latent image in the new product state, and the light emitting devices E used to form a latent image are switched to the light emitting devices E-2 when the light emitting devices E-1 are exhausted. However, the switching order of the light emitting devices E is not limited to that order. That is, the light emitting devices E-2 may be used to form a latent image when the line head 29 forms a latent image in the new product state, and the light emitting devices used to form a latent image may be switched to the light emitting devices E-1 when the light emitting devices E-2 are exhausted.

In the above-mentioned embodiment, the head controller HC performs a function of selecting the light emitting devices E to emit light. However, the function of selecting a light emitting device may be assigned to the emission control circuit 295. In this case, the emission control circuit 295 corresponds to the “control unit” in the claims.

What is claimed is:

1. An exposure head comprising:
a substrate in which a first light emitting device and a second light emitting device are arranged in a direction parallel or substantially parallel to a moving direction of an exposed side to the imaged light;
an imaging optical system imaging light from the first light emitting device and the second light emitting device to expose the exposed side; and
a control unit selecting one light emitting device from the first light emitting device and the second light emitting device, allowing the selected light emitting device to emit light in accordance with a driving signal, and allowing the non-selected light emitting device not to emit light.

2. The exposure head according to claim 1, wherein the light emitting devices are driven with a current to emit light, and
wherein the control unit, includes a current output circuit outputting a driving current corresponding to the driving signal, a selection circuit selecting one light emitting device of the first light emitting device and the second light emitting device, and a current supply switching circuit supplying the driving current to the light emitting device selected by the selection circuit and not supplying the driving current to the light emitting device not selected by the selection circuit.

3. The exposure head according to claim 2, wherein the current supply switching circuit includes a first switch outputting the driving current input to an input terminal from an output terminal connected to the first light emitting device in an ON period of time, a second switch outputting the driving current input to an input terminal from an output terminal connected to the second light emitting device in the ON period of time, and an ON-OFF switching circuit turning on one switch, which is connected to the light emitting device selected by the selection circuit, of the first switch and the second switch and turning off the other switch which is connected to the light emitting device not selected by the selection circuit.

4. The exposure head according to claim 2, wherein the current output circuit includes a transistor of which the source is connected to a constant voltage source, of which the gate is supplied with a voltage corresponding to the driving signal, and which outputs the driving current corresponding to a difference in voltage between the source and the gate from the drain.

5. The exposure head according to claim 1, wherein the control unit is disposed in the substrate.

6. The exposure head according to claim 1, wherein the first light emitting device and the second light emitting device are organic EL devices.

7. A method of controlling an exposure head comprising the steps of:
selecting one light emitting device of a first light emitting device and a second light emitting device arranged in a direction parallel or substantially parallel to a moving direction of an exposed side in an exposure head;
allowing the selected light emitting device to emit light in accordance with a driving signal to expose the exposed side to the emitted light; and
allowing the non-selected light emitting device not to emit light.

8. An image forming apparatus comprising:
a latent image holder; and
an exposure head having a substrate in which a first light emitting device and a second light emitting device are arranged in a direction parallel or substantially parallel to a moving direction of the latent image holder and an imaging optical system imaging light from the first light emitting device and the second light emitting device to expose the latent image holder to the imaged light,
wherein one light emitting device is selected from the first light emitting device and the second light emitting device, the selected light emitting device is allowed to emit light in accordance with a driving signal, and the non-selected light emitting device is allowed not to emit light.
